(19) United States
(12) Patent Application Publication
(10) Pub. No.: US 2006/0148939 A1
(43) Pub. Date: Jul. 6, 2006

(54) Fire-resistant power and/or telecommunications cable

(76) Inventor: Olivier Pinto, Lyon (FR)

Correspondence Address: SOFER & HAROUN, L.L.P., Suite 910, 317 Madison Avenue, New York, NY, 10017, US

(21) Appl. No.: 11/298,237

(22) Filed: Dec. 7, 2005

(30) Foreign Application Priority Data
Dec. 8, 2004 (FR) 04 52899

(51) Int. Cl. C08L 95/00

(52) U.S. Cl. 524/59

(57) ABSTRACT

The present invention relates to a power and/or telecommunications cable. The invention is remarkable in that the cable includes at least one constituent part based on a fire-resistant material of composition comprising a synthetic polymer and a fire-retardant filler, said fire-retardant filler comprising an inorganic compound associated with a hydrocarbon compound selected from the group of asphaltenes, malthenes, or any mixture of said components, each constituent part being selected from an insulating coating and a protective sheath.

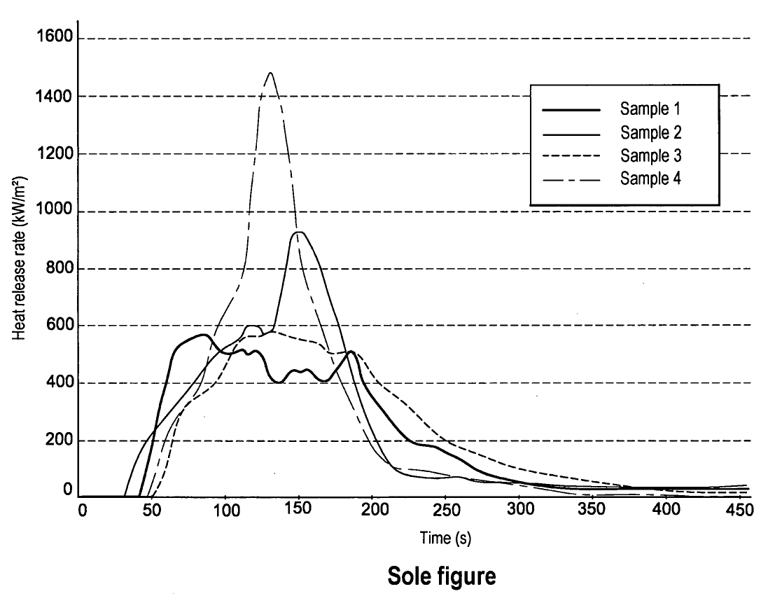

### RELATED APPLICATION

This application is related to and claims the benefit of priority from French Patent Application No. 04 52899, filed on Dec. 8, 2004, the entirety of which is incorporated herein by reference.

### FIELD OF THE INVENTION

The present invention relates to a cable capable of withstanding extreme temperature conditions.

A particularly advantageous but non-exclusive application of the invention lies in the field power or telecommunications cables that are to remain in operation during a defined length of time on being subjected to high levels of heat and/or directly to flames.

### BACKGROUND OF THE INVENTION

Nowadays, one of the major challenges of the cable-making industry is to improve the behavior and performance of cables under extreme thermal conditions, particularly those encountered during a fire. Essentially for safety reasons, it is essential to maximize the ability of a cable to retard the propagation of flames, and also to withstand fire. Any significant slowing down of flame progression represents an equivalent increase in time for evacuating premises and/or for implementing appropriate fire-extinguish means. Better resistance to fire makes it possible for a cable to continue operating for longer, since it is damaged more slowly.

Regardless of whether the cable is electrical or optical, intended for conveying power or for transmitting data, a cable is constituted in general terms by at least one conductor part extending inside at least one insulator part. It should be observed that at least one of the insulator parts may also act as protection means and/or that the cable may further comprise at least one specific protection part forming a sheath. It is also known that amongst the best insulating materials and/or protection materials used in cable-making, many of them are unfortunately also highly flammable. This applies in particular to polyolefins and their copolymers, for example polyethylene, polypropylene, ethylene and vinyl acetate copolymers, and ethylene and propylene copolymers. In any event, in practice, such excessive flammability is completely incompatible with the above-mentioned requirements to withstand fire.

In the field of cable-making, there are numerous methods for improving the fire behavior of the polymers used as insulation and/or sheathing materials.

The technique that has been in the most widespread use until now consists in implementing halogen compounds in the form of a halogen by-product dispersed in a polymer matrix, or directly in the form of a halogen-containing polymer, as applied to a polyvinyl chloride (PVC), for example. Unfortunately, present regulations are tending to ban the use of substances of that type, essentially because of their toxicity and because of their potential corrosivity, whether at the time the material is being fabricated, or while it is being decomposed by fire. This is particularly true when the decomposition in question can occur accidentally during a fire, but also applies when it is performed voluntarily by incineration. In any event, it is always particularly difficult to recycle halogen-containing materials.

That is why ever increasing recourse is being made to fire-retardant fillers that do not contain halogens, and in particular to metal hydroxides such as aluminum hydroxide or magnesium hydroxide. Nevertheless, technical solutions of that type present the drawback of requiring large quantities of filler in order to achieve a satisfactory level of effectiveness, whether in terms of ability to retard flame propagation, or in terms of resistance to fire. By way of example, the metallic hydroxide content can typically reach 150% to 200% relative to the total quantity of resin. Any massive incorporation of filler leads to a considerable increase in the viscosity of the material, and consequently to a significant decrease in speed of extrusion, thereby leading to a major drop in productivity. Adding excessive quantities of fire-retarder agents also leads to a significant deterioration in the mechanical and electrical properties of the cable.

### SUMMARY AND BRIEF OBJECT OF THE INVENTION

Thus, the technical problem to be solved by the present invention is to propose a power and/or telecommunications cable that makes it possible to avoid the problems of the state of the art, in particular by providing mechanical properties that are significantly improved, while still presenting good resistance to fire.

According to the present invention, the solution to the technical problem posed consists in that the cable includes at least one constituent part based on a fire-resistant material of composition that comprises a synthetic polymer and a fire-retardant filler, said fire-retardant filler comprising an inorganic compound associated with a hydrocarbon compound selected from the group of asphaltenes, malthenes, or any mixture of said components, each constituent part being selected from an insulating covering and a protective sheath.

It is specified that asphaltenes are aromatic and/or aliphatic compounds that could equally well be saturated or unsaturated. They constitute the bitumen fraction that is insoluble in hexane or heptane. They are also characterized by the fact that their molecular weights are relatively high, since they lie in the range 1000 to 100,000.

Malthenes are also aromatic and/or aliphatic compounds that could equally well be saturated or unsaturated. However they differ from asphaltenes in that they present lower molecular weight, and they are generally soluble in hexane or heptane.

In any event, the invention as defined in this way presents the advantage of providing a very good compromise between resistance to fire and mechanical properties. The presence of the inorganic compound within the fire-retardant filler conventionally makes it possible to increase the fire resistance of the material. To compensate for this presence also having the drawback of strongly degrading the mechanical properties of the corresponding material, it is associated simply with a compound based on malthene and/or asphaltene. Adding such a hydrocarbon compound has the advantageous consequences of not degrading performance in terms of fire resistance, and above all of greatly improving the mechanical properties of the final material.

Another advantage of the invention lies in the extremely low cost of such a fire-retardant filler, particularly when compared with the cost price of conventional fillers in the prior art. This constitutes a significant economic advantage in the field of cable-making since it is likely to encourage the commercial penetration of fire-retardant cables.

According to a feature of the invention, the inorganic compound is selected from silicon carbonate, calcium oxide, silica, alumina, or any mixture of said components. Nevertheless, it should be understood that at present calcium carbonate constitutes the preferred inorganic compound because of its excellent price/performance ratio.

In particularly advantageous manner, within the fire-retardant filler, the mass ratio between the inorganic compound and the hydrocarbon compound lies in the range 0.05 to 0.95, and preferably in the range 0.7 to 0.95.

In a presently preferred embodiment of the invention, the fire-retardant filler is natural rock asphalt. This is essentially limestone that is naturally impregnated with bitumen. It thus presents the advantage of naturally including an inorganic compound and a hydrocarbon compound in accordance with the invention. It is merely specified that the calcium carbonate content is generally greater than 80% while the bitumen content is greater than 6%.

In accordance with another advantageous characteristic of the invention, the composition comprises 5 to 200 parts by weight of fire-retardant filler per 100 parts by weight of synthetic polymer, and preferably 30 to 100 parts of fire-retardant filler.

According to another feature of the invention, the synthetic polymer is selected from a polyethylene, a polypropylene, an ethylene and propylene copolymer (EPR), an ethylene propylene diene terpolymer (EPDM), an ethylene and vinyl acetate copolymer (EVA), an ethylene and methyl acrylate copolymer (EMA), an ethylene and ethyl acrylate copolymer (EEA), an ethylene and butyl acrylate copolymer (EBA), an ethylene and octene copolymer, an ethylene-based polymer, a polypropylene-based polymer, a polyetherimide, a thermoplastic polyurethane, a polyester, a polyamide, or any mixture of said components.

In accordance with another feature of the invention, the composition further includes at least one secondary fire-retardant agent.

In particularly advantageous manner, each secondary fire-retardant agent is selected from compounds containing phosphorus such as organic or inorganic phosphates, compounds containing antimony such as antimony oxide, metallic hydroxides such as aluminum hydroxide and magnesium hydroxide, boron-based compounds such as borates, carbonates of alkali metals in groups IA and IIA such as carbonates of calcium, sodium, potassium, or magnesium, and the corresponding hydrocarbonates, tin-based compounds such as stannate and hydroxystannates, melamine, and derivatives thereof such as phosphate melamines, formophenolic resins.

According to another feature of the invention, the composition is also provided with at least one additive selected from the group of pigments, antioxidants, ultraviolet stabilizers, and also agents for facilitating plastics processing, for example lubricants, plasticizers, and thermal stabilizers.

The invention also provides any cable including at least one conductor part extending within at least one insulating covering, and having at least one insulating covering made from a composition of fire-resistant material as defined above.

The invention also relates to any cable provided with at least one conductor part extending within at least one insulating covering, and further comprising at least one protective sheath made from a composition of fire-resistant material as defined above.

It should be observed that the term “conductor part” applies equally well to a conductor of electricity and to a conductor of light. Furthermore, under all circumstances, the cable can equally well be an electrical cable or an optical cable, and in particular a cable for transporting power and/or transmitting data.

### BRIEF DESCRIPTION OF THE DRAWING

The sole FIGURE is a chart graphing time versus heat release rate in accordance with one embodiment of the present invention.

### MORE DETAILED DESCRIPTION

Other characteristics and advantages of the present invention appear from the following description an example given by way of non-limiting illustration.

### COMPARATIVE EXAMPLE

Four samples of material were prepared from different compositions in order to enable their respective performances to be compared in terms of ability to withstand fire and mechanical properties. It is specified that the compositions in question were all suitable for use in making insulating and/or sheathing and/or filler materials for power and/or telecommunications cables.

In any event, the synthetic polymer was common to all four samples. Specifically it was an ethylene vinyl acetate copolymer (EVA). Only the nature of the fire-retardant filler varied from one sample to another. Table 1 specifies the differences:

TABLE 1

| | | Fire- | | |
|---|---|---|---|---|
| | Synthetic | retardant | Inorganic | Hydrocarbon |
| Sample | polymer | filler | content | content |
| 1 | EVA | Natural rock | About 80% | About 20% |
| | | asphalt | CaCO₃ | asphaltenes |
| | | | | and malthenes |
| 2 | EVA | Gilsonite | 0% | 100% |
| | | | | asphaltenes |
| | | | | and malthenes |
| 3 | EVA | Calcium | 100% | 0% |
| | | carbonate | | |
| 4 | EVA | — | 0% | 0% |

Firstly, it should be observed that sample 1 was taken from a composition in accordance with the invention, since its fire-retardant filler was constituted by an inorganic compound in the form of calcium carbonate CaCO₃, and a hydrocarbon carbon content based on a mixture of asphaltenes and malthenes.

It should also be observed that sample 2 was characterized by the fact that its fire-retardant filler was constituted solely by an organic compound of the asphaltene/malthene type.

It should also be observed that sample 3 was remarkable in that its fire-retardant filler had no hydrocarbon filler based on a mixture of asphaltene and malthenes, i.e. it was 100% inorganic.

Sample 4 constituted the reference for this comparative example, in the sense that only the synthetic polymer was used in making it. In other words it had no fire-retardant filler.

Operating Procedure

Compositions 1 to 3 were prepared by mixing 100% resin (pcr) of each fire-retardant filler with an identical quantity of synthetic polymer, specifically to avoid falsifying subsequent comparative analyses.

Whatever the specific nature of the composition that was prepared, the steps of mixing the polymer matrix with the fire-retardant filler were always the same:
the reference temperature was set at 160° C. for the entire duration of mixing;
the synthetic polymer was introduced into an internal mixer set at 30 revolutions per minute (rpm);
the synthetic polymer was melted at 160° C. for 2 minutes (min) at 30 rpm;
melting took place at 60 rpm for 2 min;
the fire-retardant filler was introduced at 30 rpm; and
mixing took place 30 rpm for about 10 min.
   Sample Preparation

Sample 1 was physically prepared by mixing 146.7 grams (g) of ethylene and vinyl acetate copolymer (EVA) containing 28% vinyl acetate, a product sold under the trademark Evatane 28-03 by the supplier Atofina, with 73.3 g of natural rock asphalt containing about 80% ground inorganic compound screened using a 90 micron (μm) screen. That operation was naturally performed in compliance with the above-described operating procedure.

The same applied to preparing sample 2, specifically with 146.7 g of ethylene and vinyl acetate copolymer (EVA) containing 28% vinyl acetate being mixed with 73.3 g of natural rock asphalt sold under the name “Black brillant” by the supplier Ziegler Corp.

Sample 3 came from mixing 146.7 g of ethylene and vinyl acetate copolymer (EVA) containing 28% vinyl acetate with 73.3 g of ground calcium carbonate screened using a 90 μm screen, still in application of the above-described procedure.

The three samples of composite material as prepared in this way, together with reference sample 4, were then ready for being subjected to the specified characterization tests, providing they could initially be shaped adequately.

Resistance to Fire

Analyses using cone-calorimeters were undertaken to evaluate the fire behavior of samples 1 to 4.

The corresponding materials needed to be shaped for that purpose into square plates have a side of 10 centimeters (cm) and a thickness of 3 millimeters (mm). That operation was performed using a heating hydraulic press in application of the following procedure:
melting at 150° C. for 3 min;
subjecting to a pressure of 150 bar for 2 min, still at 150° C.; and
cooling with water at 150 bar for 5 min.

The samples 1 to 4 shaped in that way could then be tested by means of a cone calorimeter in application of ISO standard 5660-1 relating to the heat release rates of building materials.

Specifically, the rate at which heat was released during combustion of each sample was measured over time. The sole figure also shows the behaviors of the various materials.

Table 2 summarizes the main characteristics of samples 1 to 4 in terms of ability to resist fire, i.e. the total heat released and the maximum rate of heat release.

TABLE 2

| | Total heat released | Maximum heat release |
|---|---|---|
| Sample | (MJ/m²) | rate (kW/m²) |
| 1 | 84 | 558 |
| 2 | 99 | 955 |
| 3 | 92 | 560 |
| 4 | 103 | 1478 |

It should firstly be observed that sample 2 presented fire properties that are very mediocre. Its maximum rate of heat release, a critical criterion in the fire resistance of materials, was only 35% below that of the reference sample 4. The effectiveness of a fire-retardant filler having no inorganic compound and constituted solely by a mixture based on asphaltenes and malthenes, can consequently be seen to be insufficient in terms of resistance to fire.

In contrast, it can be seen that sample 3 had good behavior under extreme thermal conditions. Its maximum rate of heat release was much smaller than that of reference sample 4, specifically about 62% smaller. A fire-retardant filler based solely on the inorganic compound, and thus not having any mixture of the asphaltene/malthene type thus confers resistance to fire that is entirely adequate.

However it should be observed above all that sample 1 presented performance at withstanding fire that was even better. As for sample 3, its maximum rate of heat release was about 62% smaller than that of reference sample 4. In addition, the total heat released during combustion of sample 1 was less than that of the other samples, and in particular less than that of the composite materials of samples 2 and 3. These characteristics reveal the particularly advantageous effect of associating an inorganic compound with a compound containing derivatives of the asphaltene and/or malthene family, in order to prepare a fire-retardant filler that is effective.

Mechanical Properties

Tests were carried out at ambient temperature, specifically to determine the main mechanical properties of samples 1 to 4, namely breaking elongation and breaking stress.

The various measurements were performed using a Zwick 1010 traction machine using H2 type test pieces cut out from plates of material having a thickness of about 1 mm, which plates were prepared using the same operating procedure as for the above-described fire tests.

Each test piece was secured between a stationary jaw and a moving jaw that moved at a speed of 200 millimeters per minute (mm/min) during the test. The force required for moving them was measured continuously and extensometers secured to the working portion of the test piece revealed the corresponding elongation.

In order to characterize each sample material, both breaking elongation and breaking strength were measured. The method of characterization complied with IEC standard 811-1. Table 3 summaries the results of these various measurements in question.

TABLE 3

| Sample | Breaking elongation (%) | Breaking stress (MPa) |
|---|---|---|
| 1 | 686 ± 20 | 17 |
| 2 | 674 ± 42 | 10 |
| 3 | 406 ± 12 | 12 |
| 4 | 674 ± 30 | 30 |

It should firstly be observed that the breaking elongation of sample 2 remained very high whereas its breaking strength dropped quite strongly compared with the characteristics of reference sample 4. A fire-retardant filler having no inorganic compound and constituted solely by a mixture based on asphaltenes and malthenes thus degrades to some extent the mechanical properties of the polymer material in which it is dispersed.

It should also be observed that for sample 3, both the breaking elongation and the breaking strength of the material were strongly affected by adding a fire-retardant filler based solely on the inorganic compound, and thus having no mixture of the asphaltene/malthene type.

Finally, with sample 1, it can be seen that the breaking elongation was no worse than that of reference sample 4, and that its breaking strength was much greater than that of the other compound materials of samples 2 and 3. A fire-retardant filler combining an inorganic compound and a compound based on asphaltenes and malthenes consequently makes it possible to conserve mechanical properties at a very good level.

In conclusion, only a fire-retardant filler in accordance with the invention is capable of conferring both good resistance to fire and high-grade mechanical properties to a polymer material in which it is dispersed.

What is claimed is:

1. A power and/or telecommunications cable, said cable comprising:
at least one constituent part based on a fire-resistant material of composition that includes a synthetic polymer and a fire-retardant filler, said fire-retardant filler having an inorganic compound associated with a hydrocarbon compound selected from the group of asphaltenes, malthenes, or any mixture of said components, each constituent part being selected from an insulating covering and a protective sheath.

2. A cable according to claim 1, in which the inorganic compound is selected from silicon carbonate, calcium oxide, silica, alumina, or any mixture of said components.

3. A cable according to claim 1, in which the mass ratio between the inorganic compound and the hydrocarbon compound lies in the range 0.05 to 0.95, and preferably in the range 0.7 to 0.95.

4. A cable according to claim 1, in which the fire-retardant filler is natural rock asphalt.

5. A cable according to claim 1, in which the composition comprises 5 to 200 parts by weight of fire-retardant filler per 100 parts by weight of synthetic polymer, and preferably 30 to 100 parts of fire-retardant filler.

6. A cable according to claim 1, in which the synthetic polymer is selected from a polythene, a polypropylene, an ethylene and propylene copolymer (EPR), an ethylene propylene diene terpolymer (EPDM), an ethylene and vinyl acetate copolymer (EVA), an ethylene and methyl acrylate copolymer (EMA), an ethylene and ethyl acrylate copolymer (EEA), an ethylene and butyl acrylate copolymer (EBA), an ethylene and octene copolymer, an ethylene-based polymer, a polypropylene-based polymer, a polyetherimide, a thermoplastic polyurethane, a polyester, a polyamide, or any mixture of said components.

7. A cable according to claim 1, in which the composition further includes at least one secondary fire-retardant agent.

8. A cable according to claim 7, in which each secondary fire-retardant agent is selected from compounds containing phosphorus such as organic or inorganic phosphates, compounds containing antimony such as antimony oxide, metallic hydroxides such as aluminum hydroxide and magnesium hydroxide, boron-based compounds such as borates, carbonates of alkali metals in groups IA and IIA such as carbonates of calcium, sodium, potassium, or magnesium, and the corresponding hydrocarbonates, tin-based compounds such as stannate and hydroxystannates, melamine, and derivatives thereof such as phosphate melamines, formophenolic resins.

9. A cable according to claim 1, in which the composition further includes at least one additive selected from the group of lubricants, plasticizers, thermal stabilizers, pigments, antioxidants, and ultraviolet stabilizers.
